(19) United States
(12) Patent Application Publication
(10) Pub. No.: US 2003/0163386 A1
(43) Pub. Date: Aug. 28, 2003

(54) Parts delivery reminding system

(75) Inventors: Takeo Narita, Tokyo (JP); Hitoshi Iwamoto, Tokyo (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: HONDA GIKEN KOGYO KABUSHIKI KAISHA

(21) Appl. No.: 10/360,636

(22) Filed: Feb. 10, 2003

(30) Foreign Application Priority Data
Feb. 28, 2002 (JP) P. 2002-052644

(51) Int. Cl. G06F 17/60

(52) U.S. Cl. 705/26

(57) ABSTRACT

A parts delivery reminding system includes a computer connectable to a telephone and/or a facsimile of an ordering party for parts via a telephone line. The computer assigns a received order number to each of parts so ordered, so as to control a received order for parts. After the received order number has been inputted from the telephone or the facsimile, the computer stores a voice inputted through the telephone and/or an image inputted through the facsimile while matching the voice and/or the image to the received order number, and sends the voice and/or the image and the received order number matched with the voice and/or the image to another computer.

### BACKGROUND OF THE INVENTION

1. Field of the Invention

The present invention relates to a parts delivery reminding system, and more particularly to a parts delivery reminding system for enabling a reminding of a delivery of parts (for example, automotive parts) having a high urgency without any further delay.

2. Description of the Related Art

In general, with automobiles (two-wheel and four-wheel automotive vehicles), the more mileage they accumulate, the more consumable parts used thereon are required to be replaced. In addition, in case the vehicles are involved in accidents such as collision or contact with other vehicles, damaged parts are also required to be replaced.

As this occurs, for example, as shown in FIG. 4, the customer (the driver or the like) 1 comes to a dealership 2 where the customer purchased the vehicle for service or repair of the vehicle.

The dealership 2 can fulfill the request from the customer without any delay if parts are stocked thereat which are required for the service or repair. However, if no required parts are available from the stock, the dealership 2 places an order for required parts with a parts wholesaler 3 (order placement). Here, if the required parts are stocked by the parts wholesaler 3, the order by the dealership 2 can be fulfilled. However, if no required parts are stocked by the parts wholesaler 3 then, an order for the required parts has to be placed by the parts wholesaler 3 to a main supplier (such as a car manufacturer) 4.

Conventionally, the aforementioned ordering operations have been performed through telephones-or facsimiles.

With the aforesaid current systems, the following problems are liable to be caused frequently.

Namely, in general, since the dealership 2 deals with the customer 1 directly, the dealership 2 orders required parts to the parts wholesaler 3 without any delay. However, since the parts wholesaler 3 does not deal with the customer 1 directly, it is rare that the parts wholesaler 3 orders the required parts immediately. On the contrary, the parts wholesaler 3 starts to check the availability of the required parts from their stock by the gross after a certain number of orders have been received (for example, a certain number of faxed order sheets have been accumulated) and then orders the required parts to the main supplier 4. In addition, at the main supplier 4, when an order arrives thereat from the parts wholesaler 3, for example, a distribution department 5 of the supplier is first asked if the required parts are available from their stock, and in case it is found that the required parts are not stocked by the distribution department 5, the required parts are then ordered to a parts supplier 7 via a purchasing department 6 which is another department of the main supplier 4. As a result, depending on parts, the delivery of the required parts to the dealership 2 may be delayed badly. In particular, in the event that the model year of the vehicle using the parts is old or the parts are only used on vehicles of a model type which has not been marketed much, since the volumes of stocked parts for the model type are originally low, there may be a risk that the delivery of the required parts to the dealership 2 is delayed badly.

On the other hand, at the dealership 2, when finding that the delivery of the required parts is being delayed, while a reminder is sent to the parts wholesaler 3 or the urgency of the required parts (how urgently the customer wants to use his or her vehicle to be serviced or repaired) is explained to the parts wholesaler 3 by the dealership 2, information such as the reminder (or information conveying such as the urgency) does not always conveyed properly from the parts wholesaler 3 to the main supplier 4 and its departments 5 or the like, and even if it is so conveyed, the urgency of the required parts or the degree of urgency at the customer tends to be lost at each conveying stage (refer to dotted-line arrows in FIG. 4), and therefore nothing helps speed up the delivery of the required parts, as a result, leading to a complaint over or claim to customer satisfaction from the customer.

### SUMMARY OF THE INVENTION

An object of the invention is to provide a parts delivery reminding system which can solve the aforesaid problems and can enable a delivery of required parts immediately.

With a view to attaining the object, according to a first aspect of the invention, there is provided a parts delivery reminding system including:

a first computer connectable to a telephone of an ordering party for parts via a telephone line,

wherein the first computer assigns a received order number to each of parts so ordered, so as to control a received order for parts,

wherein, after the received order number has been inputted from the telephone, the first computer stores a voice inputted through the telephone while matching the voice to the received order number, and sends the voice and the received order number matched with the voice to a second computer.

According to a second aspect of the invention, there is provided a parts delivery reminding system including:

a first computer connectable to a facsimile of an ordering party for parts via a telephone line,

wherein the first computer assigns a received order number to each of parts so ordered, so as to control a received order for parts,

wherein, after the received order number has been inputted from a telephone or the facsimile, the first computer stores an image inputted through the facsimile while matching the image to the received order number, and sends the image and the received order number matched with the image to a second computer.

According to a third aspect of the invention, there is provided a parts delivery reminding system including:

a first computer connectable to a telephone and a facsimile of an ordering party for parts via a telephone line,

wherein the first computer assigns a received order number to each of parts so ordered, so as to control a received order for parts,

wherein, after the received order number has been inputted from the telephone or the facsimile, the first computer stores a voice inputted through the telephone and an image inputted through the facsimile while matching the voice and the image to the received order number, and sends the voice, the image and the received order number matched with the voice and the image to a second computer.

Note that the telephone can be constituted by a computer having a telephone function, and that the facsimile can also be constituted by a computer having a facsimile function.

According to this parts delivery reminding system of the first aspect, the following function and effectiveness can be provided.

Fog example, the computer (the first computer) is installed at a parts wholesaler and the other computers (the second computer) are installed at a main supplier (a car manufacturer).

When receiving a parts order from a dealership, the parts wholesaler controls the parts order using the computer by assigning a received order number to each of the parts so ordered. In addition, the parts wholesaler advises the dealerships of the received order numbers so assigned to the parts ordered, as required (for example, upon request from the dealership or automatically without being requested by the dealership).

Thereafter, when the dealership finds that the delivery is being delayed (or the parts ordered are critical), after the dealership connects to the computer through a telephone and inputs the advised received order numbers into the computer from the telephone, a reminder message or a message appealing for an urgent delivery is inputted in the form of voice from the telephone. Then, the computer matches the inputted voices to the received order numbers and stores the voices in the matched condition. The computer then sends the voices together with the received order numbers which match the voices, respectively, to the computer installed at the main supplier or does the same when accessed by the computer of the main supplier.

Consequently, according to this system, in the aforesaid specific case, the main supplier can listen to a so-called “real voice” of the dealership on the computer which is a message from the dealership in voice which reminds the main supplier of the delivery of the required parts or appeals for an urgent delivery of the same, whereby the criticalness of the required parts or how urgently the parts are required by the dealership can be conveyed to the main supplier in an ensured fashion.

Thus, the required parts can be delivered to the dealership without any more delay by allowing the so-called “real voice” of the dealership to be conveyed to the main supplier in such an ensured fashion, and as a result, the customer satisfaction can be improved.

Similarly, in the event that the computers are installed at the distribution and purchase departments of the main supplier or a parts supplier, the “real voice” of the dealership can also be conveyed to the departments or the parts supplier in the ensured fashion, whereby the delivery of the required parts can further be speeded up.

Further, according to the parts delivery reminding system of the second aspect, the following function and effectiveness can be provided.

Fog example, the computer (the first computer) is installed at a parts wholesaler and the other computers (the second computer) are installed at a main supplier (a car manufacturer).

When receiving a parts order from a dealership, the parts wholesaler controls the parts order using the computer by assigning a received order number to each of the parts so ordered. In addition, the parts wholesaler advises the dealerships of the received order numbers so assigned to the parts ordered, as required (for example, upon request from the dealership or automatically without being requested by the dealership).

Thereafter, when the dealership finds that the delivery is being delayed (or the parts ordered are critical), after the dealership connects to the computer through the telephone or the facsimile and inputs the advised received order numbers into the computer from the telephone or the facsimile, a reminder message or a message appealing for an urgent delivery is inputted in the form of image from the facsimile. Then, the computer matches the inputted images to the received order numbers and stores the images in the matched condition. The computer then sends the images together with the received order numbers which match the images, respectively, to the computer installed at the main supplier or does the same when accessed by the computer of the main supplier.

Consequently, according to this system, in the aforesaid specific case, the main supplier can receive on the computer a “real” message from the dealership in the form of image which reminds the main supplier of the delivery of the required parts or appeals for an urgent delivery of the same, whereby the criticalness of the required parts or how urgently the parts are required by the dealership can be conveyed to the main supplier in an ensured fashion.

Thus, the required parts can be delivered to the dealership without any more delay by allowing the “real information” from the dealership to be conveyed to the main supplier in such an ensured fashion, and as a result, the customer satisfaction can be improved.

Similarly, in the event that the computers are installed at the distribution and purchase departments of the main supplier or a parts supplier, the “real information” from the dealership can also be conveyed to the departments or the parts supplier in the ensured fashion, whereby the delivery of the required parts can further be speeded up.

Moreover, according to the system, for example, in case some defects are found in the delivered parts, the defective portions of the parts can be complained in the form of drawing.

According to the parts delivery reminding system of the third aspect, the following function and effectiveness can be provided.

Fog example, the computer (the first computer) is installed at a parts wholesaler and the other computers (the second computer) are installed at a main supplier (a car manufacturer).

When receiving a parts order from a dealership, the parts wholesaler controls the parts order using the computer by assigning a received order number to each of the parts so ordered. In addition, the parts wholesaler advises the dealerships of the received order numbers so assigned to the parts ordered, as required (for example, upon request from the dealership or automatically without being requested by the dealership).

Thereafter, when the dealership finds that the delivery is being delayed (or the parts ordered are critical), after the dealership connects to the computer through the telephone or the facsimile and inputs the advised received order numbers into the computer from the telephone or the facsimile, a reminder message or a message appealing for an urgent delivery is inputted in the forms of voice and image from the telephone and the facsimile. Then, the computer matches the inputted voices and images to the received order numbers and stores the voices and images in the matched condition. The computer then sends the voices and images together with the received order numbers which match the voices and images, respectively, to the computer installed at the main supplier or does the same when accessed by the computer of the main supplier.

Consequently, according to this system, in the aforesaid specific case, the main supplier can receive on the computer a message from the dealership in the forms of voice and image which reminds the main supplier of the delivery of the required parts or appeals for an urgent delivery of the same as “real information” from the dealership, whereby the criticalness of the required parts or how urgently the parts are required by the dealership can be conveyed to the main supplier in an ensured fashion.

Thus, the required parts can be delivered to the dealership without any more delay by allowing the “real information” from the dealership to be conveyed to the main supplier in such an ensured fashion, and as a result, the customer satisfaction can be improved.

Similarly, in the event that the computers are installed at the distribution and purchase departments of the main supplier or a parts supplier, the “real information” from the dealership can also be conveyed to the departments or the parts supplier in the ensured fashion, whereby the delivery of the required parts can further be speeded up.

Moreover, according to the system, for example, in case some defects are found in the delivered parts, since the defective portions of the parts can be complained in the forms of voice and image, the customer satisfaction can further be increased.

### BRIEF DESCRIPTION OF THE DRAWINGS

FIG. 1 is a view showing the system configuration of a parts delivery reminding system according to an embodiment of the invention;

FIG. 2A is a view showing an example of records on a database displayed on a display of a computer;

FIG. 2B is a view showing an example of records on the database displayed on the display of the computer;

FIG. 3 is a view showing an example of an image message displayed on the display of the computer; and

FIG. 4 is an explanatory view showing a related art.

### DETAILED DESCRIPTION OF THE PREFERRED EMBODIMENTS

Referring to the accompanying drawings, an embodiment of the invention will be described below.

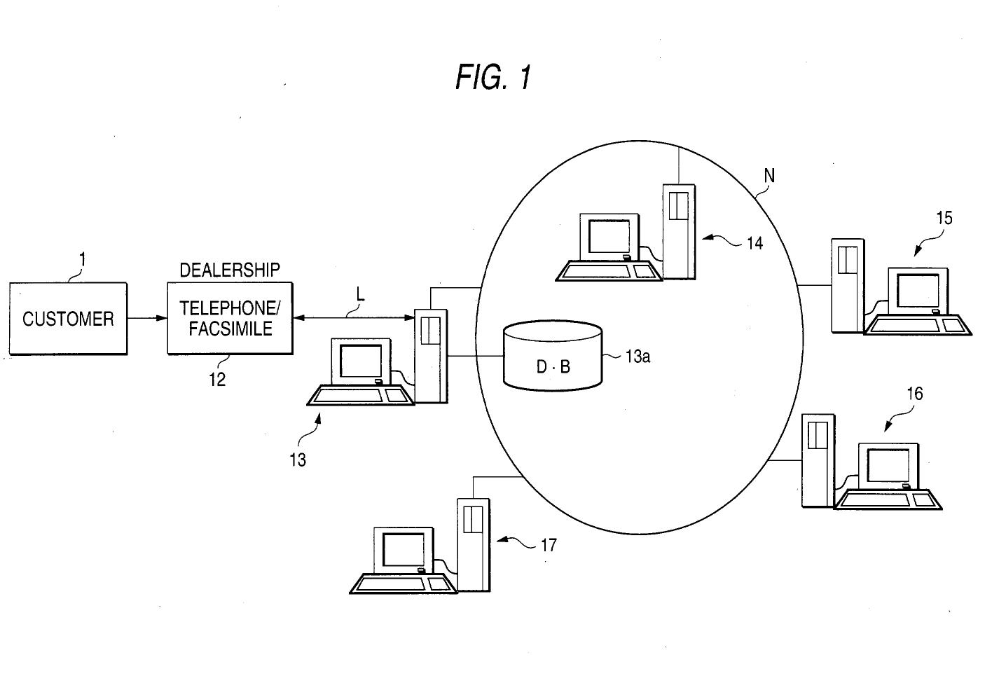

As shown in FIG. 1, the parts delivery reminding system has a computer 13 installed at a parts wholesaler and other computers including a computer 14 installed at a main supplier (a car manufacturer), a computer 15 installed at a distribution department of the car manufacturer, a computer 16 installed at a purchase department of the manufacturer and a computer 17 installed at a parts supplier. These computers are designed to respectively send and receive data via a network N (or telephone lines). The computers can be constituted by commercially available personal computers and each have at least a main body having a recording unit such as a hard disk, an operating unit such as a keyboard and a mouse, a display and a speaker.

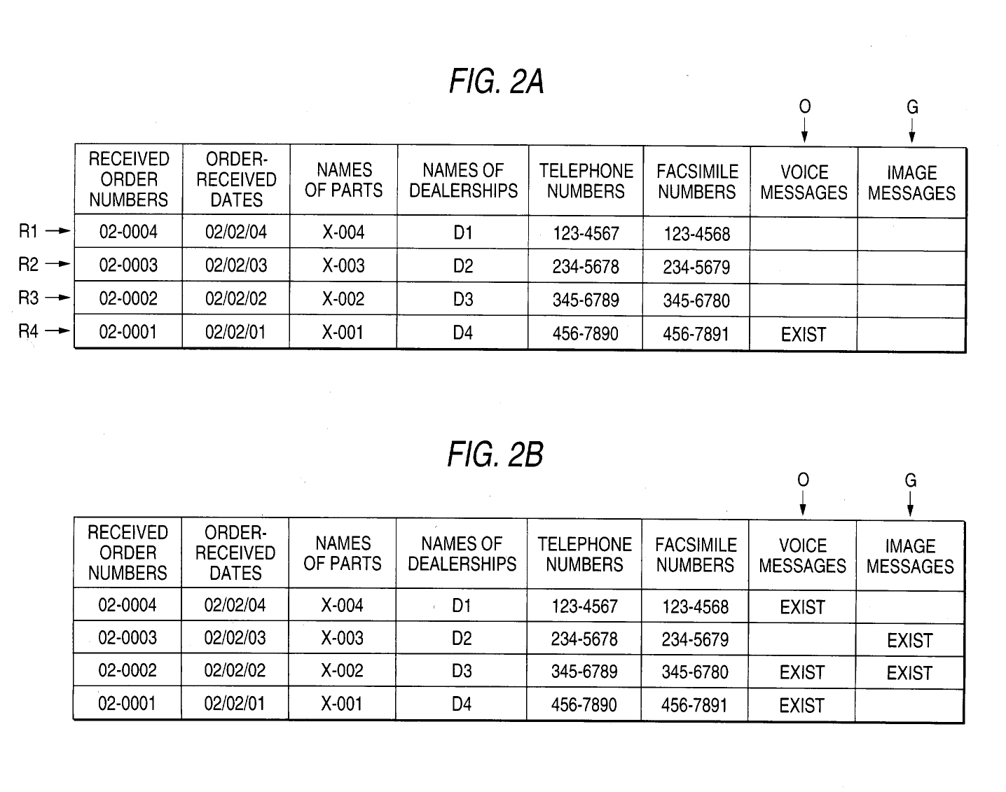

When receiving a parts order from a dealership, the computer 13 installed at the parts wholesaler is designed to control the parts order by assigning a received order number to each of the parts so ordered. The computer 13 has a database 13a, in which a database as shown in FIGS. 2A and 2B is configured. Consequently, when receiving a parts order from a dealership via a telephone or a facsimile, an operator (an employee of the parts wholesaler) of the computer 13 first displays the data as shown in FIG. 2A on the screen of the computer 13 to input required data. For example, in the event that a parts order for a part designated as X-004 is received from a dealership designated as D1 on Feb. 4, 2002, as shown in an uppermost column (of data input columns) of FIG. 2A, a received order number is inputted as, for example, “02-0004” and the order-received data, the name of the part and the name of the dealership are inputted as “02/02/04”, “X-004”, and “D1”, respectively. In addition, the telephone and facsimile numbers are also inputted.

The computer 13 can be connected to a telephone and/or facsimile 12 installed at the dealership who is a party who places parts orders via a telephone line L in such a manner that when the aforesaid predetermined items are inputted, the computer 13 automatically connects to the telephone or facsimile of the dealership (in the aforesaid case, D1) to let the dealership know the received order number assigned to the part ordered. Note that the received order number can personally be let known to the dealership via the telephone or the facsimile.

In addition, thereafter, after the received order number is inputted from the telephone or the facsimile of the dealership (namely, on condition that the relevant received order number is inputted through push-buttons of the telephone or the facsimile), the computer 13 is designed to match a voice inputted through the telephone and/or an image inputted through the facsimile to the received order number for storage therein in a matched condition.

Consequently, after having been informed of the received order number, the dealership, who is the party who places parts orders, can connect to the computer 13 via the telephone or the facsimile 12 to input the received order number through the push-buttons of the telephone or the facsimile 12 and then can input (send) a voice message from the telephone or an image through the facsimile. In addition, in a case where the dealership has a computer, the dealership can connect to the computer 13 via his or her computer to send an image taken with, for example, a digital camera.

On the other hand, when a voice message is inputted into the computer 13 at the parts wholesaler from the telephone 12 at the dealership, the computer 13 is designed not only to store the voice message (voice date) in the database 13a while matching the voice message to the received order number for storage of the voice message but also to indicate on the display that a voice message is stored for the part designated by the received order number. For example, when a voice message is inputted for the part designated by the received order number “02-0004” shown in FIG. 2A, as shown in FIG. 2B, a word “exist” is indicated in a voice message column “O”. In addition, when image data (an image message) is similarly inputted for a part such as designated as “02-0003”, as shown in FIG. 2B, a word “exist” is indicated in an image message column “G”. Thus, the data indicated in FIG. 2B shows further that a voice message and an image message exist (are stored) for a part “02-0002” and that a voice message exits (is stored) for a part “02-0001”.

When the portion indicating the word “exist” on the screen of the display is clicked by the mouse or the like, the computer 13 is designed to reproduce the voice message from the speaker or indicate the image on the display. Consequently, the operator can listen to the voice message or see the image massage by clicking the portion indicating the word “exist”. For example, when the “exist” portion for the part “02-0004” is clicked, a voice message from the ordering party (the dealership) D1 for the part can be listened to, similarly when the “exist” portion for the part “02-0003” is clicked, an image message from the ordering party (the dealership) D2 for the part can be seen, when the “exist” portion for the part “02-0002” is clicked, a voice message or an image message from the ordering party (the dealership) D3 for the part can be listened to or seen, and when the “exist” portion for the part “02-0001” is clicked, a voice message from the ordering party (the dealership) D4 for the part can be listened to. As will be described later, the other computers 14 to 17 are configured similarly in this respect.

The computer 13 is also designed to automatically or in reply to accesses from the other computers 14 to 17 send to the other computers the above information; the voice message for the part designated by the received order number “02-0004”, the image message for the part designated by the received order number “02-0003”, the voice message and the image message for the part designated by the received order number “02-0002” and the voice message for the part designated by the received order number “02-0002” at the points in time when the messages for the respective parts are stored.

Consequently, by operating their computers 14 to 17, people in charge (operators of the computers) at the main supplier (the car manufacturer), the distribution department and the purchase department of the main supplier, and the parts supplier can bring up the same display as that shown in FIG. 2B on the screens of their computers 14 to 17 and they can then listen to the voice messages or display the image message for the relevant parts by clicking the respective “exist” portions on the display of their computers 14. to 17.

Thus, the parts delivery reminding system as has been described heretofore includes the computer 13 as follows. That is, the computer 13 can control a received order for parts by assigning a received order number to each of parts so ordered, and can be connected to the telephone and the facsimile of the ordering party for parts via the telephone line L. Further, the computer 13 can, after the received order numbers have been inputted from the telephone or the facsimile, match voices inputted through the telephone and images inputted through the facsimile to the received order numbers, respectively, for storage therein, and can send to other computers 14 to 17 the voices and the images together with the received order numbers which match the voices and the images, respectively. Accordingly, in the parts delivery reminding system, the following function and effectiveness can be provided.

Fog example, the computer 13 is installed at a parts wholesaler and the other computers 14 to 17 are installed at a main supplier (a car manufacturer).

When receiving a parts order from a dealership, the parts wholesaler controls the parts order using the computer 13 by assigning a received order number to each of the parts so ordered. In addition, the parts wholesaler advises the dealerships of the received order numbers so assigned to the parts ordered, as required (for example, upon request from the dealership or automatically without being requested by the dealership).

Thereafter, when the dealership finds that the delivery is being delayed (or the parts ordered are urgent), after the dealership connects to the computer 13 through the telephone or the facsimile and inputs the advised received order numbers into the computer 13 from the telephone and/or the facsimile 12, a reminder message or a message appealing for an urgent delivery is inputted in the forms of voice and/or image from the telephone and/or the facsimile 12. Then, the computer 13 matches the inputted voices and/or images to the received order numbers and stores the voices and images in the matched condition. The computer 13 then sends the voices and images together with the received order numbers which match the voices and images, respectively, to the computer 14 installed at the main supplier or does the same when accessed by the computer 14 of the main supplier.

Consequently, according to this system, in the aforesaid specific case, the main supplier can receive on the computer 14 a message from the dealership in the forms of voice and/or image which reminds the main supplier of the delivery of the required parts or appeals for an urgent delivery of the same as “real information” from the dealership, whereby the urgency of the required parts or how urgently the parts are required by the dealership can be conveyed to the main supplier in an ensured fashion. In this embodiment, since the system includes as the other computers the computer 14 installed at the main supplier (the car manufacturer), the computer 15 installed at the distribution department of the car manufacturer, the computer 16 installed at the purchase department of the manufacturer and the computer 17 installed at the parts supplier, those departments and the parts supplier can also receive the same message from the dealership in the forms of voice and/or image which reminds the main supplier of the delivery of the required parts or appeals for an urgent delivery of the same as “real information” from the dealership, whereby the urgency of the required parts or how urgently the parts are required by the dealership can be conveyed to the departments and the parts supplier in an ensured fashion.

Thus, the required parts can be delivered to the dealership without any more delay by allowing the “real information” from the dealership to be conveyed to the main supplier in such an ensured fashion, and as a result, the customer satisfaction can be improved.

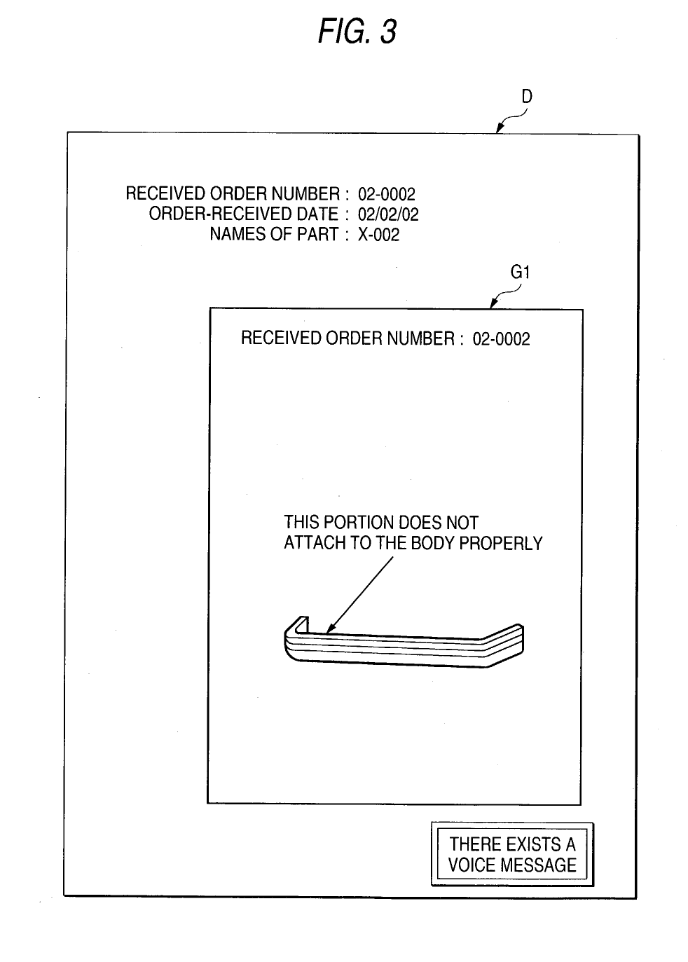

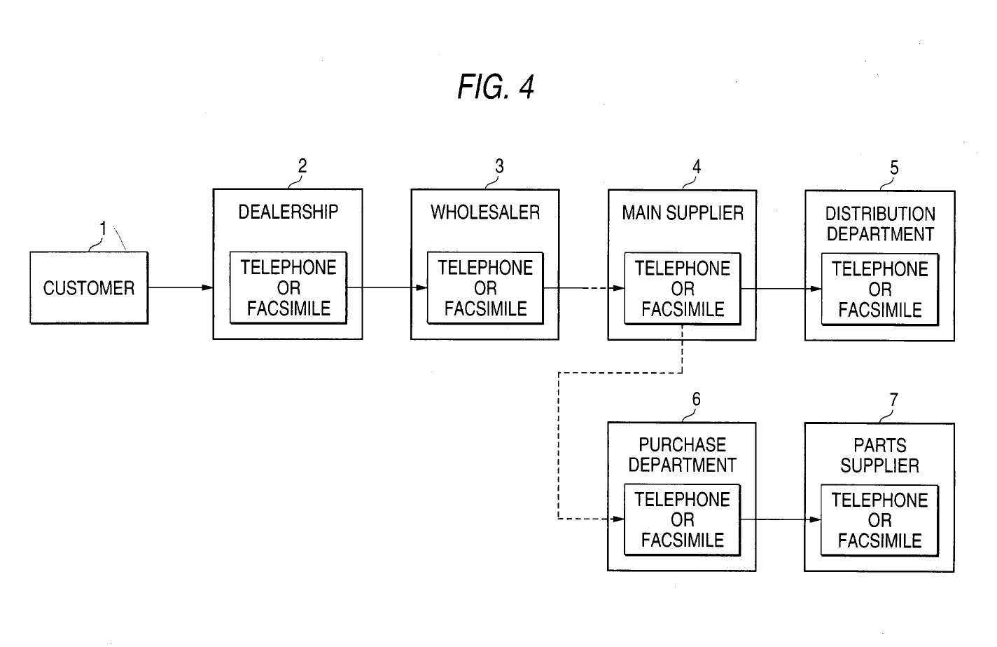

Moreover, according to the system, for example, in case some defects are found in the delivered parts, as shown in FIG. 3, since the defective portions of the parts can be complained in the forms of voice and image, the customer satisfaction can further be increased. Note that a portion designated by “G1” on a display screen (display) D shown in FIG. 3 denotes a portion indicating image data sent through the facsimile or the like. In addition, a sentence reading “there exists a voice message” is indicated on the display screen D, and the voice message can be opened by clicking a portion indicating the same. In the figure, the defective portion is described as reading “this portion does not attach to the body properly” with an arrow indicating the specific portion.

Thus, while the embodiment of the invention has been described heretofore, the invention is not limited to the embodiment but may be modified as required variously without departing from the spirit and scope of the invention.

For example, in the embodiment the computer 13 is configured such that the computer 13 can, after the received order numbers have been inputted through the telephone or the facsimile, match the voices inputted from the telephone and images inputted from the facsimile to the received order numbers for storage therein in the matched condition and then send the voices and images together with the received order numbers which match the voices and images, respectively, to the other computers. However, the computer 13 may be configured such that the computer 13 can, after the received order numbers have been inputted from the telephone, match only the voices inputted from the telephone to the received order numbers for storage therein and send the voices to the other computers together with the received order numbers which match the voices, respectively, or can, after the received numbers have been inputted from the telephone or the facsimile, match only the images inputted through the facsimile to the received order numbers for storage therein and then send to the other computers the images together with the received order numbers which match the images, respectively.

In addition, while there are used as the other computers four computers in the above embodiment, there may used one computer for that purpose.

Further, the computer installed in the parts wholesaler, the main supplier, the distribution department or the purchase department may be structured such that, when the message with the reminding message or the message with urgency is sent from the dealership, an unopened message newly sent is displayed in a different manner from the already clicked message (for example, dot pattern), so that the operator can easily confirm the message newly sent.

What is claimed is:

1. A parts delivery reminding system comprising:
a first computer connectable to a telephone of an ordering party for parts via a telephone line,
wherein said first computer assigns a received order number to each of parts so ordered, so as to control a received order for parts,
wherein, after said received order number has been inputted from said telephone, said first computer stores a voice inputted through said telephone while matching said voice to said received order number, and sends said voice and said received order number matched with said voice to a second computer.

2. The parts delivery reminding system according to claim 1, wherein said ordering party includes a third computer having a function of said telephone.

3. A parts delivery reminding system comprising:
a first computer connectable to a facsimile of an ordering party for parts via a telephone line,
wherein said first computer assigns a received order number to each of parts so ordered, so as to control a received order for parts,
wherein, after said received order number has been inputted from a telephone or said facsimile, said first computer stores an image inputted through said facsimile while matching said image to said received order number, and sends said image and said received order number matched with said image to a second computer.

4. The parts delivery reminding system according to claim 3, wherein said ordering party includes a third computer having a function of said facsimile.

5. Aparts delivery reminding system comprising:
a first computer connectable to a telephone and a facsimile of an ordering party for parts via a telephone line,
wherein said first computer assigns a received order number to each of parts so ordered, so as to control a received order for parts,
wherein, after said received order number has been inputted from said telephone or said facsimile, said first computer stores a voice inputted through said telephone and an image inputted through said facsimile while matching said voice and said image to said received order number, and sends said voice, said image and said received order number matched with said voice and said image to a second computer.

6. The parts delivery reminding system according to claim 5, wherein said ordering party includes a third computer having a function of said facsimile.

7. The parts delivery reminding system according to claim 5, wherein said ordering party includes a third computer having a function of said facsimile.

8. A parts delivery reminding system comprising:
a first computer connectable to a communication unit of an ordering party for parts via a communication line,
wherein said first computer assigns a received order number to each of parts so ordered, so as to control a received order for parts,
wherein, after said received order number has been inputted from said communication unit, said first computer stores at least one of voice and image inputted through said communication unit while matching said at least one of voice and image to said received order number, and sends said at least one of voice and image and said received order number matched with said at least one of voice and image to a second computer.
